(19) United States
(12) Patent Application Publication
(10) Pub. No.: US 2007/0219800 A1
(43) Pub. Date: Sep. 20, 2007

(54) Voice message systems and methods

(75) Inventors: James Allen Hymel, Dallas, TX (US); Prathibha Sri Tammana, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporation

(21) Appl. No.: 11/374,791

(22) Filed: Mar. 14, 2006

(51) Int. Cl. G10L 21/00

(52) U.S. Cl. 704/270

(57) ABSTRACT

A voice message system is provided that includes a voice control that receives voice messages and identified voice message pattern types within respective voice messages. The voice message system also includes a graphical user interface that displays voice message representations associated with the voice messages and visual indicator identifiers that reference portions of the voice message representations that contain the identified voice message pattern types.

### TECHNICAL FIELD

The present invention relates to communications, and in particular to voice message systems and methods.

### BACKGROUND

Currently available voice message systems perform similarly to an answer machine. Users can leave voice messages by accessing the voice message system, following instructions, and leaving a voice message. To retrieve voice messages, the recipient of the messages (hereinafter “the recipient”) will access the voice message system, and listen to the voice messages. Often people sending voice messages leave long voice messages (e.g., several minutes), with important information at the end of the voice message. For example, in a typical voice message, the sender of the voice message (hereinafter “the sender”) will often leave pertinent information, such as his/her phone number at the middle or at the end of the voice message. Thus, with current voice message systems, a recipient of the voice message would need to listen to the entire voice message to obtain the pertinent information.

In currently available voice message systems, a visual interface can be included that displays indicia of a voice message. The indicia includes information that can be determined from a caller identification system (CID). The indicia can include the phone number from which the person is calling, the time the person called and the name that is officially listed with the phone number. Other currently available systems include a voice synthesizer that can convert information obtained from a CID system to audible speech. Thus, the recipient can listen to the information without playing the message. However, the currently available systems are limited to displaying information that is ascertainable without analyzing the contents of the voice message.

Often, however, the sender wishes to have the message returned at number different from the number the sender originally called. For example, the sender might leave a message using his/her “work” phone, and wish a call to be returned at a “home” phone. In the currently available systems, the recipient would still need to listen to the entire message to determine the phone number the message sender wished to be called. Additionally, often the sender is not the person to whom the phone number is listed. For example, often in businesses, phone numbers are listed under the name of the business. In the currently available systems, the recipient would not be able to ascertain the name of the sender without listening to the entire message.

### SUMMARY

In one aspect of the invention, a voice message system is provided that includes a voice control that receives voice messages and identified voice message pattern types within respective voice messages. The voice message system also includes a graphical user interface that displays voice message representations associated with the voice messages and visual indicator identifiers that reference portions of the voice message representations that contain the identified voice message pattern types.

In another aspect of the invention, a voice message system is provided that includes a pattern matching component that analyzes voice messages to identify voice message patterns within the voice messages that matches one or more selected voice message pattern types. The voice message system also includes a message control that receives and stores voice messages in a memory and builds voice message pattern references that identify locations and voice message pattern types within voice messages for respective voice messages.

In yet another aspect of the invention, a method for identifying and displaying voice message patterns within voice messages associated with a voice message system is provided. The method includes analyzing a voice message to identify at least one voice message pattern that matches a respective voice message pattern type. The method also includes displaying a voice message representation of the voice message and at least one visual indicator that identifies a given voice message pattern type within the voice message.

### BRIEF DESCRIPTION OF THE DRAWINGS

FIG. 1 illustrates a block diagram of a voice message system in accordance with an aspect of the invention.

FIG. 2 illustrates a multi-user voice message system in accordance with an aspect of the invention.

FIG. 3 illustrates an example of a graphical user interface implemented in accordance with an aspect of the invention.

FIG. 4 illustrates another example of a graphical user interface implemented in accordance with an aspect of the invention.

FIG. 5 illustrates yet another example of a graphical user interface implemented in accordance with an aspect of the invention.

FIG. 6 illustrates yet a further example of a graphical user interface implemented in accordance with an aspect of the invention.

FIG. 7 illustrates a flow chart of a method for implementing a voice message system in accordance with an aspect of the invention.

FIG. 8 illustrates a flow chart of another method for implementing a voice message system in accordance with an aspect of the invention.

### DETAILED DESCRIPTION

The present invention relates to a system and method for implementing a voice message system. A voice message is typically a recorded audio message that is stored at one time, and played back at a later time. The message could be stored for example, on a digital medium. The present invention includes a voice control that receives voice messages and identifies voice message pattern types within the voice message. The present invention also includes a graphical user interface (GUI) that can display voice message representations associated with the voice messages and visual indicator identifiers that reference portions of the voice messages that contain the identified voice message pattern types.

Often when a person leaves a voice message, that person communicates vital information at or near the end of the voice message (e.g., the person's telephone number). The present invention allows a voice message recipient to play a selected portion of the message, and/or play the voice message in a non-linear fashion (e.g., play the last five seconds of a voice message first). The present invention accomplishes this by receiving a voice message, and analyzing the voice message, wherein the voice message is searched for one or more preselected voice pattern types (e.g., phrases). If one or more preselected voice pattern types are found in the voice message, the system stores a reference (e.g., a pointer) to the location of the preselected voice pattern in the voice message to indicate the location of the preselected voice pattern within the voice message. When a recipient of the voice message reviews the voice message, the recipient would have the option to play a portion of the voice message associated with one of the preselected voice pattern types, the entire voice message, or a combination of both.

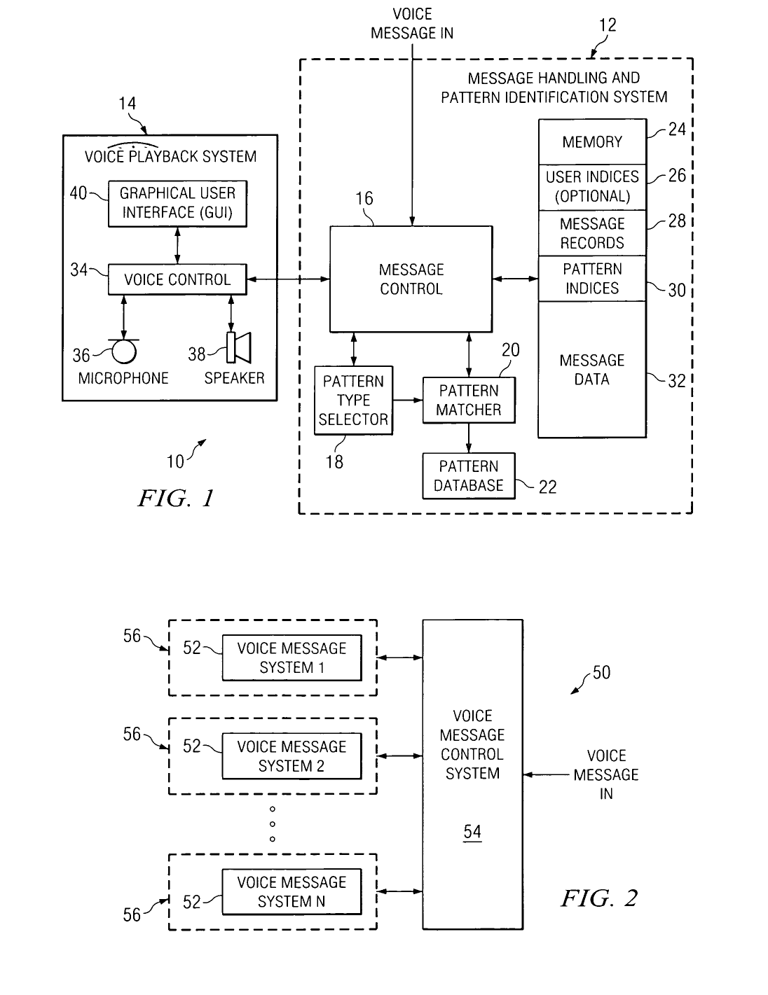

FIG. 1 illustrates an example of a voice message system 10 in accordance with an aspect of the invention. The voice message system 10 includes a message handling and pattern identification system (hereinafter “message handling system”) 12 connected to a voice playback system 14. The message handling system 12 includes a message control 16. The message control 16 could be implemented as, for example, an advanced reduced instruction set computer machines (ARM) processor, digital signal processor (DSP) or a microcontroller. The message control 16 is connected to a pattern type selector 18 and a pattern matcher 20. The pattern type selector 18 is also connected to the pattern matcher 20. It is to be understood that the pattern type selector 18 and the pattern matcher 20 could, for example, be implemented on the same processor as the message control 16. In such a case, the pattern type selector 18 and the pattern matcher 20 could be implemented as programs executed by the message control 16. Alternatively, the pattern type selector 18 and the pattern matcher 20 could be implemented on one or more separate circuits, such as an ARM processor or an application specific integrated circuit (ASIC). The pattern matcher 20 can access a pattern database 22. The pattern database 22 could be implemented as volatile or non-volatile memory, such as FLASH random access memory or one or more hard disks. The message control 16 is further connected to a memory 24. The memory 24 can be implemented as a volatile or non-volatile memory, such as FLASH RAM, or one or more hard disks. The memory 24 can include optional user indices 26 that allows multiple users to store messages in the memory 24. The memory 24 also includes one or more message records 28 that can include one or more pattern indices 30 and message data 32 fields.

The voice playback system 14 includes a voice control 34. The voice control 34 is connected to a microphone 36 and a loudspeaker 38. The voice control 34 could be implemented, for example, as an ARM processor or a microcontroller. The voice control is also connected to a GUI 40. It is to be understood that voice message system 10 could be implemented as an integrated system wherein the voice playback system 14 and the message handling system 12 are implemented as a stand alone system (e.g., an answering machine, a smart telephone, or a computer). Alternatively, the message handling system 12 and the voice playback system 14 could be implemented as separate entities. For example, voice message system 10 could be implemented as a voice mail system wherein the message handing system 12 is implemented as a voice message server (e.g., a computer system) and the voice playback system 14 is implemented as a voice message client (e.g., a wireless phone, a personal digital assistant (PDA), etc.).

Initially, the voice message system 10 operates in a normal mode of operation. In the normal mode of operation, the voice message system waits to enter a receiving mode of operation, or a retrieval mode of operation. In a typical voice message system 10, a sender of a voice message (hereinafter “the sender”) initially attempts to speak with a recipient of the voice message (hereinafter “the recipient”) directly. For example, when the sender dials a phone number for the recipient, typically a recipient's phone will provide an audible indicator that there is an incoming call (e.g., a “ring”). After a predetermine time, if the phone is not answered, the sender will be forwarded to the voice message system 10, and the voice message system 10 will enter the receiving mode of operation. Typically, the sender will hear a message, often created by the recipient, requesting that the sender leave a voice message (e.g., a greeting). Additionally or alternatively, the message handling system 12 could prompt the sender for information that identifies the recipient (e.g., a recipient's voice message box number). A voice message is then provided to the message handling system 12 at the message control 16.

When the message control 16 receives a voice message, the message control 16 encodes the voice message into a digital format and stores the voice message in the memory 24. To store the voice message in the memory 24, message control 16 could create a message record 28 for the incoming voice message. The voice message can be stored in the message data field 32 of the associated message record 28 in a digitally encoded or compressed format. If the voice message system 10 is implemented in a multi-user environment, the memory 24 could include one or more user indices 26 that includes information that identifies the recipient of the voice message. The user indices 26 could be implemented, for example, as one or more pointers that points to particular message records 28 that are associated with a particular recipient.

While the incoming voice message is being stored in the memory 24, or sometime thereafter, the voice message can searched for one or more preselected voice patterns. The message control 16 provides a signal to the pattern type selector 18 that selects one or more preselected voice pattern types (e.g., a phone number pattern, a name pattern, an e-mail pattern, an address pattern, etc.). The pattern type selector 18 provides the pattern matcher 20 with a signal that indicates for which voice pattern types the voice message is to be searched. The pattern matcher 20 access the pattern database 22 to retrieve one or more preselected voice patterns associated with each of the one or more voice patterns types. The message control 16 provides the pattern matcher 20 with the voice message. The pattern matcher 20 parses through the voice message searching for the at least one voice pattern.

The pattern matcher 20 could include, for example, a speech detector program (e.g., hardware or software coded) that analyzes speech in the voice message. In such a case, the at least one voice pattern could be implemented as, for example, specific terms or phrases of speech that could lead into vital information. For example, when leaving a voice message, often the sender will preface a phone number with a phrase such as, “I can be reached at . . . ,” wherein the actual phone number follows the phrase. Thus, when the voice message is searched, the pattern matcher 20 compares the voice message to the at least one voice pattern. If a match is found within the voice message, the pattern matcher 20 can create a pattern index or reference into the voice message that indicates the location within the voice message where the match was found. Additionally, the pattern index could include data that indicates the duration of the voice message that includes the vital information (e.g., two to three seconds). The pattern matcher 20 provides the message control 16 with the pattern index, and the message control 16 provides the index to the memory 24, where the index could be stored as one of the pattern indices 30 in the message record associated 28 with the voice message.

It is to be understood that the voice message could be searched for additional or alternative matching voice pattern types that indicate that other vital information is to be provided in the voice message. The voice patterns could indicate that the sender's name, the senders email address or the sender's home address are being divulged in the voice message. Furthermore, each voice pattern type could be associated with multiple voice patterns such that pattern matcher will search the voice message for a number of different phrases that indicate the same or similar piece of vital information that is included in the voice message. For example, when leaving of telephone number instead of using the phrase mentioned above, the sender of the message could alternatively preface the phone number with, “My phone number is . . . ” Further still, the pattern matcher 20 could be implemented to search for the actual vital information, instead of a phrase that proceeds the vital information. In the example of the sender leaving his/her telephone number, the pattern matcher 20 could search the voice message for a series of numbers being divulged.

Optionally, the voice message system 10 can be implemented such that one or more voice messages include an associated priority level. The priority level could be associated with one or more of the voice pattern types. For example, one or more of the voice pattern types could indicate that if the voice message includes one or more particular voice message patterns, the voice message is to be considered “HIGH PRIORITY.” Additionally or alternatively, one or more voice pattern types could indicate that if the voice message includes one or more particular voice patterns, the voice message is to be considered “URGENT” (e.g., a message with a highest priority). In such an implementation, the pattern index associated with the voice pattern type with the priority level could include information that indicates the priority level.

Optionally, the voice message system 10 can be implemented such that incoming voice messages can be rearranged by the message control 16 based on the results of the searching performed by the pattern matcher 20. As an example, the voice message system 10 can be implemented such that if the sender provides his/her phone number at the end of the voice message, the message control 16 can rearrange the voice message such as to place the portion of the voice message that includes the sender's phone number at or near the beginning of the voice message. In such an implementation, typically, the message control would also update one or more pattern indices that are associated with the phone number to reflect the rearrangement of the voice message.

It is additionally to be understood that the pattern matcher could search for multiple voice patterns at a substantially concurrent time (e.g., via parallel processing). Additionally, or alternatively, the pattern matcher 20 could parse the message multiple times searching for a different voice pattern on each parse. When the voice message has been stored and searched, the voice message system 10 can return to the normal mode of operation.

In a typical voice message system 10, to access the stored messages, the recipient of one or more voice messages will employ the voice playback system 14 to access the message handling system 12. In a stand alone system, such as when the message handling system 12 and the voice playback system 14 are an integrated unit, the voice playback system could, for example, access the message handling system 12 when a user actuates one or more actuators (not shown) on the voice playback system (e.g., a “MESSAGES” button). Alternatively, if the voice playback system 14 and the message handling system 12 are implemented as separate units (e.g., in a voice mail system), the voice playback system 14 could access the message handling system 12 for example, by dialing a specific telephone number, and/or providing a username and/or password to the message handling system 12. When the voice playback system 14 accesses the message handling system 12, the voice message system 10 enters the retrieval mode of operation.

Upon the voice message system 10 entering the retrieval mode of operation, the voice control 34 and the message control 16 can be communicatively coupled. The voice control 34 can signal the message control 16 to control the pattern type selector 18. The voice control 34 could be employed to select one or more predefined voice pattern types, such as the aforementioned sender's name, the senders phone number, the sender's email address, and the sender's home address. When the voice control 34 selects the at least one voice pattern types, the voice control 34 provides the message control 16 with a signal that indicates which voice pattern type or voice pattern types of an incoming voice message is to be searched. The message control 16 in turn, provides the pattern type selector 18 with a signal that indicates the one or more voice pattern types that were selected by the voice playback system 14. The pattern type selector 18 can store information that indicates the selected voice pattern types.

Additionally or alternatively, the recipient could indicate that one or more user defined voice pattern types are to be defined and searched. In such a case, the recipient could input the name of the user defined voice pattern type through a voice recording or some other means (e.g., a numeric keypad), and record through the microphone 36, one or more specific voice patterns associated with the user defined voice pattern types. The voice control 34 can provide the name of the user defined voice pattern type and the one or more newly recorded voice patterns to the message control 34. The message control 16 could signal the pattern type selector 18 to search incoming voice messages for the user defined voice pattern type. The message control 16 could also encode the one or more newly recorded voice pattern into a digitally encoded or compressed format, and provide the pattern matcher 20 with the one or more encoded patterns and information that associates the one or more encoded patterns with the user defined voice pattern type. The pattern matcher 20 could store the one or more encoded patterns in the pattern database 22 along with the associated one or more user defined voice pattern types.

After the at least one voice pattern has been selected, the voice control 34 requests voice messages from the message control 16. The message control 16 accesses the memory 24 to retrieve the message records 28. If the message handling system 12 implements the optional user indices, the message control 16 can access the user indices 26 to determine if one or more message records 28 are associated with the recipient that is currently attempting to retrieve the voice messages. The message control 16 provides the one or more message records 28 to the voice control 34. The one or more message records 28 include the message data 32 and pattern indices 30 associated with the message record 28. The voice control 34 analyzes the one or more message records 28 and provides an output on the GUI 40 that represents the structure of at least one voice message that was stored by the at least one message record 28. The recipient can employ the voice playback system 14 to play back part or all of the at least one voice message through the speaker. Additionally, if the optional priority levels are included, the GUI 40 could display the voice messages in a specific order based on priority (e.g., a highest priority level to a lowest priority level).

Additionally, it is to be understood, that the voice message system 10 could be implemented such that the voice control 34 could cause the message control 16 to remove one or more voice messages from the memory 24. It is possible to design the voice playback system 14 such the voice control downloads the message records 28 from the message handling system 12, wherein the message records 28 could be removed from the memory 24 when they are provided to the voice playback system 14. Alternatively, the voice message system 10 could be designed such that the voice playback system 14 acts a thin client with limited data storage, such that voice playback system 14 receives message records 28 each time the recipient accesses his/her voice messages. In such an implementation, the voice messages could be removed from the memory 24 when the recipient chooses to do so (e.g., the recipient selects a “delete” option for a particular voice message). In a typical voice playback system 14, the recipient has the option of terminating the connection between the voice playback system 14 and the message handling system 12 by, for example hanging up the phone, or selecting an “exit” option on the GUI 40. When the voice playback system 14 disconnects from the message handling system 12, the voice message system 12 returns to the normal mode of operation.

FIG. 2 illustrates an example of multi-user voice message system 50 in accordance with an aspect of the invention. FIG. 2 illustrates N number of voice message systems 52, wherein N is an integer greater than or equal to one. Each of the N number of voice message systems 52 could be implemented, for example as the voice message system 10 shown in FIG. 1. A voice message control system 54 is connected to the N number of voice message systems 52. The voice message control system 54 could be implemented as, for example, a private branch exchange (PBX) controller. In such an implementation, the voice message systems 52 could be implemented, for example, as smart phones (sometimes known as office phones).

In a typical multi-user voice message system 50, each of the N voice message systems 52 are usually assigned to a particular recipient. Each voice message system 52 could represent a telephone extension (hereinafter “extension”) 56. When the voice message control system 54 receives an incoming phone call, the voice message control system 54 forwards the phone call to the appropriate extension 56. The voice message control system 54 can determine the appropriate extension 56 based on the implementation of the multi-user voice message system 50. In one example, each extension 56 can have an associated “direct dial” number, wherein each extension 56 has a separate phone number. In such an example, the voice message control system 54 reads the phone number dialed by the incoming call, and forwards the phone call to the appropriate extension 56. Additionally or alternatively, the multi-user voice message system 50 has one or more “universal numbers” wherein the incoming voice message control system 54 receives the incoming phone call, and provides a menu that prompts the caller for a desired extension 56.

In a typical multi-user voice message system 50, each voice message system 52 can have three modes of operation. The first mode of operation is the normal mode of operation. In the normal mode of operation, each voice message system 52 waits for an indication to enter another mode of operation. When an incoming phone call is received at a given voice message system 52, the given voice message system 52 enters a message receiving mode of operation. When the given voice message system 52 is accessed by a recipient to retrieve one or more voice messages, or to change one or more operating conditions, the given voice message system 52 enters a message retrieval mode of operation.

When the voice message control system 50 forwards a phone call to an extension 56, the corresponding voice message system 52 will enter the message receiving mode of operation and the corresponding voice message system 52 will provide at least one indicia that an incoming phone call is present. The indicia could be implemented as an audible signal (e.g., a ring) or a visual stimulus (e.g., a flashing light). After a predetermined amount of time (e.g., twenty seconds), if the phone call is not answered, the corresponding voice message system 52 could provide the caller (the sender) with a request that the sender provide a message for the person to whom the voice message system 52 is assigned (the recipient). The request could be implemented, for example, as an audio recording, made by the recipient at a prior time (e.g., a greeting). After the greeting is provided, the corresponding voice message system 52 could record a voice message from the sender. Additionally, or alternatively, the corresponding voice message system 52 could inquire as to whether or not the sender wished to provide the same voice message to one or more other extensions 56. In such an implementation, the corresponding voice message system 52 could provide the voice message to the voice message control system 54, along with information that indicated the additional extensions 56. The voice message control system 54 could provide the voice message to the appropriate one or more extensions 56 and their corresponding voice message systems 52. When the sender is finished leaving the voice message, typically, the sender will hang up, and the corresponding voice message system 52 will return to the normal mode of operation.

When the corresponding voice message system 52 receives the voice message from the sender, the corresponding voice message system 52 stores the voice message. Concurrently, or at a later, time, the voice message system 52 can search the voice message for one or more preselected voice pattern types, as described above. If a match is found, the corresponding voice message system 52 can store an indicator that indicates the location in which the match was found in the voice message. Optionally, the indicator could also store information that indicates the duration of the one or more matched voice patterns.

The recipient can access his/her assigned voice message system 52 to retrieve one or more voice messages and to control the operation of the voice message system 52. Typically, the recipient can cause the assigned voice message system 52 to enter the retrieval mode of operation. The recipient can initiate the retrieval mode of operation by, for example, actuating an actuator (e.g., pressing a “MESSAGES” button) on the assigned voice message system 52. Optionally, the voice message system can prompt the recipient for identification (e.g., a username and/or password) before permitting access to the assigned voice message system 52. Once the recipient has accessed the assigned voice message system 52, the recipient can control the operation of the assigned voice message system 52. For example, the recipient could add or remove one or more voice pattern types for which the assigned voice message system 52 will search incoming voice messages. Additionally, the recipient could control the assigned voice message system 52 to search voice messages for one or more user defined voice pattern types, as described above. Additionally, the voice message system 52 could be implemented such that the recipient could also change his/her greeting message.

In a typical voice message system 52, the voice message system 52 provides the recipient with information on a GUI regarding one or more voice messages stored in the voice message system 52. The information provided by the voice message system 52 regarding the one or more voice messages can include information that indicates if one or more voice patterns were found in the message. Using the information on the GUI, the recipient can select to play a portion or all of the voice message. Additionally, the recipient can delete one or more of the voice messages. In a typical voice message system 52, the recipient can terminate the retrieval mode of operation and return the voice message system 52 to a normal mode of operation for example, by selecting a disconnect option in the GUI, or hanging up the phone.

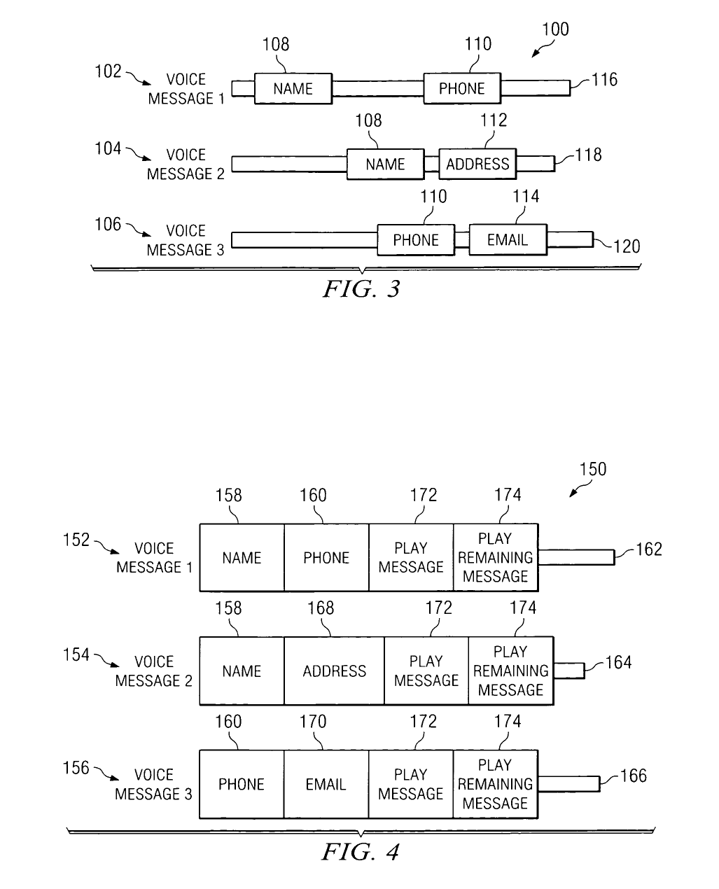

FIG. 3 illustrates an example of information 100, that can be provided on the GUI of a voice message system discussed above, in accordance with an aspect of the invention. In the present example, the information 100 includes three different visual stimuli 102, 104, 106 for voice messages 1, 2 and 3, respectively. The visual stimuli 102, 104, 106 can be, for example, voice message representations. In the first voice message representation 102, “NAME” and “PHONE” indicators 108, 110 are illustrated. The NAME indicator 108 could, for example, indicate that a voice pattern was found in voice message 1 that matched a voice pattern for which voice message 1 was searched. The matched voice pattern that caused the NAME indicator 108 to be included could be, for example, a voice pattern that indicated that the sender has left his/her name, as discussed above. Likewise, the PHONE indicator 110 could indicate that a voice pattern was found in voice message 1 that indicated that the sender has left his/her phone number. It is to be understood that the second and third voice message representations 104, 106 associated with voice messages 2 and 3, respectively, include other indicators. In addition to including a NAME indicator 108, the second voice message representation includes an ADDRESS indicator 112. The ADDRESS indicator 112 could indicate a voice pattern that indicated that the sender of voice message 2 has left his/her address in voice message 2. In the third voice message representation 106 associated with voice message 3, an EMAIL indicator 114 is included. The EMAIL indicator 114 could indicate that a voice pattern that indicates that the sender of voice message 3 has left his/her email address in voice message 3.

Additionally, the voice message representations 102, 104 and 106 can include a bar 116, 118 and 120 that indicates the duration of the corresponding voice message. As it is illustrated, the bar 116 associated with voice message 1 is longer than the bar 118 associated with voice message 2. The relative lengths of the bars 116, 118 could indicate that voice message 1 has a longer duration than voice message 2. Furthermore, in the voice message representation of voice message 1, the NAME indicator 108 is located to the left of the PHONE indicator 110. The placement of the indicator on the bar 116 could indicate the location of the matched phrase relative to the length of the voice message. In the present example, in voice message 1, the location of the NAME indicator 108 could indicate that the name of the sender is located the first half of the message, while the location of the PHONE indicator 110 could indicate that the phone number of the sender is located in the second half of the voice message.

The information 100 could be displayed, for example on a touch screen, such that each indicator could represent a virtual button. Additionally or alternatively, the information 100 could be displayed on a GUI that includes a virtual pointer (e.g., a mouse) such that each indicator could still represent a virtual button. As an example, when the NAME virtual button 108 is activated, the voice message system could play the portion of the associated voice message that includes the senders name on a speaker. Likewise, when the PHONE virtual button 110 is activated, the voice message system could play the portion of the associated voice message that includes the sender's phone number. Alternatively, the voice message system could be configured such that activation of a virtual button (such as the NAME virtual button 108), could, for example, cause the voice message system to play the voice message from the start of the portion of the voice message corresponding to the virtual button pressed, through the end of the voice message.

FIG. 4 illustrates another example of information 150 that can be provided on the GUI of a voice message system discussed above, in accordance with an aspect of the invention. FIG. 4 includes voice message representations 152, 154 and 156 associated with voice messages 1, 2 and 3, respectively. The voice message representation 152 associated with voice message 1 includes the indicators of NAME 158 and PHONE 160. The NAME indicator 158 could, for example, indicate that a voice pattern was found in voice message 1 that matched a voice pattern for which voice message 1 was searched. The matched voice pattern that caused the NAME indicator 158 to be included could be, for example, a voice pattern that indicated that the sender has left his/her name, as discussed above. Likewise, the PHONE indicator 160 could indicate that a voice pattern was found in voice message 1 that indicated that the sender has left his/her phone number. Additionally, each of the voice message representations includes a bar graph 162, 164 and 166. The bar graphs 162, 164 and 166 could indicate the duration of the associated voice message. Thus, in FIG. 4, voice message 1 could have a longer duration that voice message 2 and voice message 3, while voice message 3 could have a longer duration than voice message 2.

In the information 150 illustrated in FIG. 4, voice messages 1, 2 and 3 could have been rearranged, as discussed above. In the voice message representation 152 associated with message 1, the NAME indicator 158 and the PHONE indicator 160 are shown to be in the front portion of voice message 1. The voice message system could have been implemented such that the portion of voice message 1 that included the sender's name was moved to the front of the voice message. Likewise, the portion of the voice message that included the sender's phone number could have been moved to a portion of the voice message that closely followed the portion of the voice message that included the sender's name. It is to be understood that voice messages 2 and 3 could have been rearranged in a similar fashion.

The second and third voice message representations 154, 156 associated with voice messages 2 and 3, respectively, include other indicators. In addition to including a NAME indicator 158, the second voice message representation 154 includes an ADDRESS indicator 168. The ADDRESS indicator 168 could indicate that that a voice pattern that indicated that the sender of voice message 2 has left his/her address in voice message 2. The third voice message representation 156 associated with voice message 3, an EMAIL indicator 170 is included. The EMAIL indicator 170 could indicate that a voice pattern that indicated that the sender of voice message 3 has left his/her email address in voice message 3.

The information 150 could be displayed, for example on a touch screen, such that each indicator represents a virtual button. Additionally or alternatively, the information 150 could be displayed on a GUI that includes a virtual pointer (e.g., a mouse) such that each indicator could still represent a virtual button. As an example, when a NAME virtual button 158 is activated, the voice message system could play the portion of the voice message that includes the senders name on a speaker. Likewise, when a PHONE virtual button 160 is activated, the voice message system could play the portion of the voice message that includes the sender's phone number. Alternatively, the voice message system could be configured such that activation of a virtual button (such as the NAME virtual button 158) could, for example cause the voice message system to play the voice message from the start of the portion of the voice message corresponding to the virtual button pressed, through the end of the voice message.

In FIG. 4, each of the voice messages 1, 2 and 3 also include virtual buttons PLAY MESSAGE 172 and PLAY REMAINING MESSAGE 174. The PLAY MESSAGE 172 button could be implemented such that, when activated, the voice message system plays the entire voice message. The PLAY REMAINING MESSAGE 174 could be implemented such that, when activated, the voice message system plays the portion of the voice message that is not associated with a matching voice pattern.

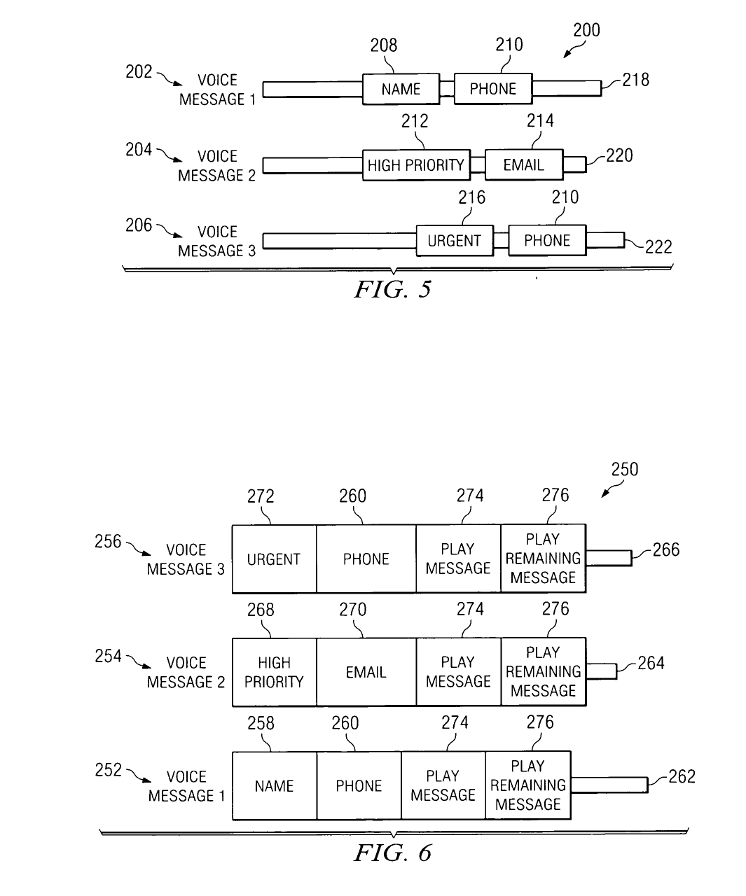

FIG. 5 illustrates another example of information 200 that can be provided on a GUI of a voice message system discussed above, in accordance with an aspect of the invention. FIG. 5 includes voice message representations 202, 204 and 206 associated with voice messages 1, 2 and 3, respectively. The voice message representation 202 associated with voice message 1 includes the indicators NAME 208 and PHONE 210. The NAME indicator 208 could, for example, indicate that a voice pattern was found in voice message 1 that matched a voice pattern for which voice message 1 was searched. The matched voice pattern that caused the NAME indicator 208 to be included could be, for example, a voice pattern that indicated that the sender has left his/her name, as discussed above. Likewise, the PHONE indicator 210 could indicate that a voice pattern was found in voice message 1 that indicated that the sender has left his/her phone number.

The second and third voice message representations 204 and 206 that represent voice messages 2 and 3 respectively include additional indicators. The second voice message representations include a HIGH PRIORITY 212 and EMAIL 214 indicators. The EMAIL indicator 214 could indicate that a voice pattern was found in voice message 2 that indicated that the sender has left his/her email address. The HIGH PRIORITY 212 indicator could indicate that a voice pattern was found in voice message 2 that indicates that important information is included in the voice message, and accordingly, the voice message should be listened to promptly. The voice pattern that could indicate that such important information is included in the voice message could be, for example, a term and/or phrase such as “immediately” and/or “as soon as possible.” Voice message 3 includes an URGENT indicator 216. The URGENT indicator 216 could indicate that a voice pattern was found in voice message 3 that indicates that critical information is included in voice message. The voice pattern that could indicate that such critical information is included in the voice message could be, for example, the term and/or phrase “emergency” and/or the name of one or more of the recipients relatives (e.g., the recipient's child's name).

Additionally, each of the voice message representations can include a bar 218, 220 and 222 that can indicate the duration of voice message. As illustrated, the bar 218 associated with voice message 1 is longer than the bar 220 associated with voice message 2. The relative lengths of the bars 218 and 220 could indicate that voice message 1 is longer than voice message 2. Furthermore, on the representation of voice message 1 202, the NAME indicator 208 is located to the left of the PHONE indicator 210. The placement of the indicator within each bar could indicate the location of the matched voice pattern relative to the length of the voice message. In the present example, in voice message 1, the location of the NAME indicator 208 could indicate that the name of the sender is located the first half of the message, while the PHONE indicator 210, could indicate that the phone number of the sender is located in the second half of the voice message.

The information 200 could be displayed, for example on a touch screen, such that each indicator represents a virtual button. Additionally or alternatively, the information 200 could be displayed on a GUI that includes a virtual pointer (e.g., a mouse) such that each indicator could still represent a virtual button. As an example, when the NAME virtual button 208 is activated, the voice message system could play the portion of the voice message that includes the senders name on a speaker. Likewise, when the PHONE virtual button 210 is activated, the voice message system could play the portion of the voice message that includes the sender's phone number. Alternatively, the voice message system could be configured such that activation of a virtual button (such as the NAME virtual button 208) could, for example, cause the voice message system to play the voice message from the start of the portion of the voice message corresponding to the virtual button pressed, through the end of the voice message.

FIG. 6 illustrates another example of information 250 that can be provided on the GUI of a voice message system discussed above, in accordance with an aspect of the invention. FIG. 6 includes voice message representations 252, 254 and 256 associated with voice messages 1, 2 and 3, respectively. The voice message representation 252 associated with voice message 1 includes the indicators NAME 258 and PHONE 260. The NAME indicator 258 could, for example, indicate that a voice pattern was found in voice message 1 that matched a voice pattern for which voice message 1 was searched. The matched voice pattern that caused the NAME indicator 258 to be included could be, for example, a voice pattern that indicated that the sender has left his/her name, as discussed above. Likewise, the PHONE indicator 260 could indicate that a voice pattern was found in voice message 1 that indicated that the sender has left his/her phone number. Additionally, each of the voice message representations 252, 254 and 256 includes a bar graph 262, 264 and 266. The bar graphs 262, 264 and 266 could indicate the duration of the associated voice message. Thus, in FIG. 6, voice message 1 could have a longer duration than voice messages 2 and 3.

In the information 250 illustrated in FIG. 4, voice messages 1, 2 and 3 could have been rearranged, as discussed above. In the voice message representation 252 associated with message 1, the NAME indicator 258 and the PHONE indicator 260 are shown to be in the front portion of voice message 1. The voice message system could have been implemented such that the portion of voice message 1 that included the sender's name was moved to front of the voice message. Likewise, the portion of the voice message that included the sender's phone number could have been moved to a portion of the voice message that closely followed the portion of the voice message that included the senders name. It is to be understood that voice messages 2 and 3 could have been rearranged in a similar fashion.

The second and third voice message representations 254 and 256 that represent voice messages 2 and 3, respectively, include additional indicators. The second voice message representation 254 includes a HIGH PRIORITY indicator 268 and an EMAIL indicator 270. The EMAIL indicator 268 could indicate that a voice pattern was found in voice message 2 that indicated that the sender has left his/her email address. The HIGH PRIORITY indicator 268 could indicate that a voice pattern was found in voice message 2 that indicates that important information is included in the voice message, and accordingly, the voice message should be listened to promptly. The voice pattern that could indicate that such important information is included in the voice message could be, for example, a term and/or phrase such as “immediately” or “as soon as possible.” Voice message 3 includes an URGENT indicator 272. The URGENT indicator could indicate that a voice pattern was found in voice message 3 that indicates that critical information is included in voice message. The voice pattern that could indicate that such critical information is included in the voice message could be, for example, the term and/or phrase “emergency” and/or the name of one or more of the recipient's relatives (e.g., child's name). Additionally, the GUI could, for example, provide the messages in the order of their priority levels (e.g., from a highest priority to a lowest priority) as shown in FIG. 6.

The information 250 could be displayed, for example on a touch screen, such that each indicator could represent a virtual button. Additionally or alternatively, the information 250 could be displayed on a GUI that includes a virtual pointer (e.g., a mouse) such that each indicator could still represent a virtual button. As an example, when a NAME virtual button 258 is activated, the voice message system could play the portion of the voice message that includes the senders name on a speaker. Likewise, when the PHONE virtual button 260 is activated, the voice message system could play the portion of the voice message that includes the sender's phone number. Alternatively, the voice message system could be configured such that activation of a virtual button (such as the NAME virtual button) could, for example, cause the voice message system to play the voice message from the start of the portion of the voice message corresponding to the virtual button pressed, through the end of the voice message.

In FIG. 6, each of the voice messages 1, 2 and 3 also include virtual buttons PLAY MESSAGE 274 and PLAY REMAINING MESSAGE 276. The PLAY MESSAGE 274 virtual button could be implemented such that, when activated, the voice message system plays the entire voice message. The PLAY REMAINING MESSAGE 276 virtual button could be implemented such that, when activated, the voice message system plays the portion of the voice message that is not associated with a matching voice pattern.

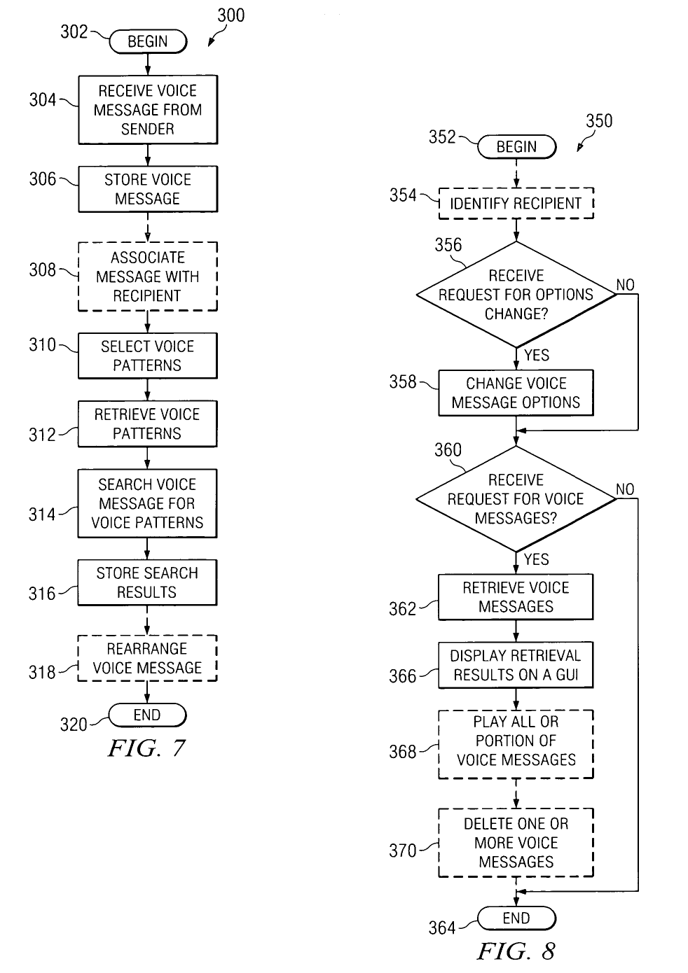

FIGS. 7-8 illustrate methodologies in accordance with aspects of the present invention, wherein optional blocks are illustrated with dashed lines. FIG. 7 illustrates a flow diagram of a process 300 for receiving and processing a voice message in accordance with an aspect of the invention. The process 300 begins at 302. At 302, a message handling system switches to a receiving mode of operation from a normal mode of operation. The receiving mode of operation can be initiated by, for example, a message handling system receiving an unanswered phone call from a sender for a predetermined amount of time (e.g., 30 seconds). At 302, a message control in the message handling system can also optionally provide an introductory message to a sender, requesting that the sender leave a voice message (e.g., a greeting). The message control could be implemented, for example, by an ARM processor, a DSP or a microcontroller. The process 300 proceeds to 304. At 304, the message handling system receives a voice message from the sender at a message control. The message control can digitally encode or compress the message. The process 300 proceeds to 306.

At 306, the message control stores the voice message in a memory. The memory could be implemented as volatile RAM or non-volatile RAM, such as FLASH RAM or one or more hard disks. The memory stores the voice message in a message record. The message record can be implemented, for example, as a data structure. The message record can include data fields such as message data and pattern indices. The message data field can be implemented to store the voice message, for example, in a digital format. The process 300 proceeds to optional 308 or 310.

Optionally, at 308, the message control associates the voice message with one or more intended recipients. The message control can associate the voice message with the recipients by, for example, storing one or more user indices in the memory for each recipient of the voice message system that points to one or more message records. The process 300 proceeds to 310. At 310, the message control signals a pattern selector to provide a signal that causes a pattern matcher to select one or more preselected voice pattern types. The pattern selector could be implemented as a circuit separate from the message control, such as a processor or an ASIC, or as a program executed by the message control, implemented as hardware or software. The process 300 proceeds to 312.

At 312, the pattern matcher receives the signal provided by the pattern selector, and accesses a pattern database that contains the one or more voice patterns associated with the one or more voice pattern types. As with the pattern selector, the pattern matcher could also be implemented as a separate circuit, such as a processor or an ASIC, or as a program executed by the message control, implemented as hardware or software. The pattern matcher could include, for example, a speech detector program (e.g., hardware or software coded) that analyzes speech in the voice message. Additionally, the pattern database could be implemented as a memory, such as volatile RAM or non-volatile RAM such as FLASH RAM or one or more hard disks. The process 300 proceeds to 314.

At 314, the pattern matcher signals the message control to provide the voice message for which the one or more voice patterns is to be searched. The pattern matcher searches the message for a phrase or term of speech that matches the one or more preselected voice patterns. If a match is found, the pattern matcher provides a signal to the message control that can indicate the location in the voice message where the match was found. The signal can also include information that provides the duration of the matched voice pattern. Optionally, one or more of the voice patterns could be associated with a priority level, such that if a match is found in the voice message with the voice pattern, the voice message is indicated to have a particular priority level (e.g., a normal priority level, a high priority level, and a highest priority level). The process 300 proceeds to 316.

At 316, the message control then stores the results of the voice pattern search in the memory. The search results can be stored, for example, in the pattern indices data field of the message record. The pattern indices field can include one or more pointers that points to positions within the message data field. The positions pointed to in the message data can include, for example, the beginning of a matched voice pattern, and optionally, the duration of the matched voice pattern. The process 300 optionally proceeds to block 318 or ends at block 320.

At 318, the voice message system can be rearranged by the message control based on the results of the search performed by the pattern matcher. As an example, the voice message system can be implemented such that if the sender provides his/her phone number at the end of the voice message, the message control can rearrange the voice message such as to place the portion of the voice message that includes the sender's phone number at or near the beginning of the voice message. In such an implementation, typically, the message control would also update one or more pattern indices that are associated with the phone number to reflect the rearranging. The process 300 proceeds to 320, where the voice message system returns to the normal mode of operation.

The process 300 illustrated in FIG. 7 is shown to be operating in a serial fashion. It is to be understood that one or more of the steps could be performed concurrently or in a different order. Additionally, it is to be understood that in some implementations, one or more steps may be repeated multiple times.

FIG. 8 illustrates a flow diagram of a process 350 for retrieving and playing one or more voice messages in accordance with an aspect of the invention. The process 350 begins at 352. At 352, a recipient causes a voice message system to switch to a retrieval mode of operation from a normal mode of operation. It is to be understood that the method by which the recipient could initiate the retrieval mode of operation would vary based on the implementation of the voice message system. In a typical voice message system, the recipient interacts with a voice playback system. The voice message system could be implemented such that the voice playback system and a message handling system are an integrated unit, such as a smart phone. If the voice playback system and the message handling system are implemented as an integrated unit, the recipient could initiate the retrieval mode of operation, by, for example, actuating an actuator (e.g., pressing a “MESSAGES” button) on the voice playback system. Alternatively, the voice playback system and the message handling system could be separate units. The voice playback system could be implemented, for example, as a wireless phone, a PDA, or a personal computer. If the voice playback system and the message handling system are implemented as separate units, the recipient could initiate the retrieval mode of operation, by, for example, dialing a particular phone number. The process 350 proceeds to optional block 354 or to block 356.

At optional block 354, the recipient is identified. Block 354 could be implemented, for example in a multi-user voice message system. The recipient could be identified, for example, by providing a username and/or password to the message handling system via the voice playback system. If the recipient is identified, the process 350 proceeds to 356. If the recipient is not identified, the connection between the voice playback system and the message handling system could be terminated, such that the voice message system would return to a normal mode of operation (not shown).

At 356, a determination is made as to whether the recipient has indicated an options change. If the determination is positive (e.g., YES) the process 350 proceeds to 358. If the determination is negative (e.g., NO), the process 350 proceeds to 360. The recipient can indicate an options change through the voice playback system. In one implementation, the recipient could, for example, indicate the options change through interaction with a GUI. The GUI could provide a signal to a voice control indicating a particular option is to be changed. The GUI could be implemented, for example, as a visual screen that includes one or more indicators that can be activated (e.g., virtual buttons). The voice control could be implemented, for example, as an ARM processor, a DSP or a microcontroller. It is to be understood that the method of activating the indicators depends on the particular implementation of the voice playback system. As an example, the GUI could be implemented, for example as a touch screen, or a screen with a virtual pointer (e.g., a mouse).

At 358, voice message options are changed. In response to receiving a signal from the GUI indicating that an option is to be changed, the voice control provides a signal to the message handling system that indicates the change is to be made. The options that can be changed could include, for example, the initial greeting heard by a potential sender. When changing the greeting, the message handling system could prompt the recipient to record a new greeting through the voice playback system's microphone. The options could also include, for example, the addition or removal of one or more voice patterns for which received messages are searched (e.g., a telephone number, the sender's name, etc.). Accordingly, the recipient can tailor the voice message system to specific needs and interests. The message handling system can store the changes. The process 350 proceeds to 360.

At 360 another determination is made as to whether or not a request was received for voice messages. If the determination is affirmative (e.g., YES) the process 350 proceeds to 362. If the determination is negative (e.g., NO), the process 350 proceeds to 364. It is to be understood that the request can be performed automatically, such that the recipient need not take any specific action to initiate the request when the voice message system enters the retrieval mode of operation. Alternatively, the voice playback system could be implemented such that the recipient could activate an indicator (e.g., a GET MESSAGES virtual button) that signals the voice control to request messages from the message handling system. The message handling system could respond to the request by providing one or more message records to the voice control. The message records can include, for example, message data that contains a voice message in an encoded or compressed digital format. Additionally, the message record could include one or more pattern indices. The pattern indices can include, for example, one or more pointers that point to positions in the voice message data that correspond to locations within the voice message where matching voice patterns were found. The pattern indices could also include, for example, information that indicates which voice pattern types were found in the corresponding voice message, and the duration of the voice pattern types. The process 350 proceeds to 366.

At 366, the voice control controls the GUI to provide the recipient with one or more voice message representations that represent the voice messages. The voice message representations can include indicators that, when activated cause the voice control to play specific portions of the voice message through a speaker. Optionally, one or more of the voice messages can have an associated priority level. If one or more of the voice messages has an associated priority level, the voice control can cause the GUI to display the voice messages in an order corresponding to their priority level (e.g., a highest priority level to a lowest priority level). The process 350 proceeds to optional block 368, optional block 370 or block 364.

At optional block 368, the recipient activates one or more of the indicators on the GUI. The GUI provides a signal to the voice control that indicates that one or more particular indicators have been activated. The voice control can then play the portion of the voice message that is associated with the particular indicator through the speaker. For example, one or more indicators may be associated with the sender's name. When such an indicator is activated, the voice control provides an audio output signal to the speaker that includes at least the portion of the voice message that includes the sender's name. The process 350 proceeds to optional block 370 or to end block 364.

At optional block 370, one or more voice messages are deleted from the message handling system and/or the voice playback system. The voice messages could be deleted, for example, by the recipient activating an indicator on the GUI associated with a particular message that indicates that the voice message is to be deleted. Additionally, or alternatively, once the voice messages have been provided to the voice playback system, the message handling system could delete the messages from the message handling system automatically. Automatic deletion could be implemented, for example, in a voice message system wherein the voice control downloads and stores the voice messages on the voice playback system. The process 350 proceeds to 364.

At 364, the voice message system returns from the retrieval mode of operation to the normal mode of operation. At 364, the message handling system can terminate the connection between the voice playback system and the message handling system. The termination could be performed automatically if no action is taken by recipient for a predetermined amount of time (e.g., 30 seconds). Additionally or alternatively, the recipient could activate an indicator that causes the voice control to signal the message handling system that the connection should be terminated.

The process 350 illustrated in FIG. 8 is shown to be operating in a serial fashion. It is to be understood that one or more of the steps could be performed concurrently or in a different order. Additionally, it is to be understood that in some implementations, one or more steps may be repeated multiple times.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications, and variations that fall within the spirit and scope of the appended claims.

What is claimed is:

1. A voice message system comprising:
a voice control that receives voice messages and identified voice message pattern types within respective voice messages; and
a graphical user interface that displays voice message representations associated with the voice messages and visual indicator identifiers that reference portions of the voice message representations that contain the identified voice message pattern types.

2. The system of claim 1, the voice control further receiving location information of the identified message pattern types within the respective voice messages, the graphical user interface being configured to display the visual indicator identifiers within associated locations of the voice message representations.

3. The system of claim 1, the graphical user interface being configured to display the visual indicator identifiers in a front portion of the voice message representations.

4. The system of claim 1, the graphical user interface being configured to display priority visual indicator identifiers based on one or more qualifying identified voice message pattern types within respective voice messages.

5. The system of claim 1, the graphical user interface being configured to arrange the voice messages to be displayed in an order of priority.

6. The system of claim 1, the graphical user interface being configured to provide selectability for playing out portions of the voice message associated with the identified voice message patterns via the voice control.

7. The system of claim 1, further comprising:
a pattern matching component that analyzes a voice message to identify voice message patterns within the voice message that matches one or more selected voice message pattern types; and
a pattern database that contains a plurality of voice message pattern types, the pattern matching component employing the selected voice message pattern types from the plurality of message pattern types.

8. The system of claim 7, further comprising a pattern selector that identifies message pattern types to be matched by the pattern matching component, the pattern selector being one of preprogrammed and programmable.

9. The system of claim 1, further comprising a message control that receives and stores voice messages and builds pattern indices that identify locations and voice message pattern types within voice messages for respective voice messages.

10. The system of claim 1, wherein the identified voice message pattern types comprise at least one of a name, an address, an E-mail address, a phone number and one or more qualifying words that indicate a priority associated with the voice message.

11. A voice message system comprising:
a pattern matching component that analyzes voice messages to identify voice message patterns within the voice messages that matches one or more selected voice message pattern types; and
a message control that receives and stores voice messages in a memory and builds voice message pattern references that identify locations and voice message pattern types within voice messages for respective voice messages.

12. The system of claim 1, wherein the identified voice message pattern types comprise at least one of a name, an address, an E-mail address, a phone number and one or more qualifying words that indicate a priority associated with the voice message.

13. The system of claim 11, wherein the message control builds pattern indices that identify locations and voice message pattern types within voice messages for respective voice messages and rearranges voice message based on voice message pattern types within respective voice messages.

14. The system of claim 13, wherein the message control builds user indices that identify voice messages and associated pattern indices for respective users.

15. The system of claim 11, wherein the message control rearranges at least a portion of voice message based on voice message pattern types within respective voice messages.

16. The system of claim 11, further comprising a plurality of voice playback systems communicatively coupled to the voice message system for retrieving voice messages and identified voice message patterns within the voice messages from the voice message system, each of the plurality of voice playback systems comprising:
a voice control that receives voice messages and identified voice message pattern types within respective voice messages from the message control in response to a message request; and
a graphical user interface that displays voice message representations associated with the voice messages and visual indicator identifiers that reference portions of the voice message representations that contain the identified voice message pattern types, the graphical user interface being configured to provide selectability for playing out portions of the voice message associated with the identified voice message patterns via the voice control.

17. A method for identifying and displaying voice message patterns within voice messages associated with a voice message system, the method comprising:
analyzing a voice message to identify at least one voice message pattern that matches a respective voice message pattern type; and
displaying a voice message representation of the voice message and at least one visual indicator that identifies a given voice message pattern type within the voice message.

18. The method of claim 17, further comprising displaying the at least one visual indicator identifier within associated locations of the voice message representation indicative of the location of the voice message pattern within the voice message.

19. The method of claim 17, further comprising displaying the at least one visual indicator in a front portion of the voice message representation.

20. The method of claim 17, further comprising analyzing the voice message to identify one or more qualifying voice message pattern types within the voice message and displaying a priority visual indicator identifier if a match of the one or more qualifying voice message pattern types identified.

21. The method of claim 17, further comprising providing selectability for playing out portions of the voice message associated with the identified voice message patterns.

22. The method of claim 17, wherein the message pattern type comprise at least one of a name, an address, an E-mail address, a phone number and one or more qualifying words that indicate a priority associated with the voice message.

23. The method of claim 17, further comprising programming the voice message system to analyze the voice message for voice message patterns matching user identified voice message pattern types.
